(19) United States
(12) Patent Application Publication
(10) Pub. No.: US 2005/0031854 A1
(43) Pub. Date: Feb. 10, 2005

(54) Lateral melt feed extrusion nozzle for films or slabs

(76) Inventors: Hans Lorenz, Darmstadt (DE); Roland Schuchmann, Ober-Ramstadt (DE); Christoph Krohmer, Stockstadt (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/494,730

(22) PCT Filed: Nov. 21, 2002
(86) PCT No.: PCT/EP02/13045

(30) Foreign Application Priority Data
Dec. 18, 2001 (DE) 101 62 353.4

(51) Int. Cl. B29C 47/08

(52) U.S. Cl. 428/332; 264/176.1; 425/461

(57) ABSTRACT

The invention relates to an extrusion nozzle for shaping extruded melts produced from thermoplastics to webs of film or slabs. Said nozzle substantially comprises a nozzle body (1), at least one opening for feeding the melt (2) to a distributing channel (3) with at least one retaining island (4) and a slit die-type nozzle emergence zone (5). The melt (2) is fed to the distributing channel (3) laterally relative the extrusion direction (E) predetermined by the nozzle emergence zone (5). The invention further relates to a corresponding production method and to films and slabs produced according to the inventive method.

The invention relates to an extrusion die for films or sheets with lateral melt feed, a corresponding production process and films and sheets produced according to the invention.

### PRIOR ART

Extrusion dies for the shaping of extruded melts of thermoplastic materials into film or sheet webs, substantially comprising the die body, a central orifice for the melt feed into a manifold with a restricting island and a slot-shaped die outlet region are known.

Extrusion dies for round cross sections, such as pipes or blow moldings, with lateral melt feed are known for example (see for example Winter, H. H. (1986) Polymer Engineering Science 26/8, pages 543-553, EP-A 0 876 895, U.S. Pat. No. 4,344,907).

Extrusion dies for the extrusion of flat webs of thermoplastic materials are known for example from DE-A 4 220 839. Corresponding dies have manifolds which, in plan view, have the shape of a coat hanger or a fish tail. In this case, the melt feeding orifice widens on both sides to form a manifold which has the width of the desired extrudate in film or sheet form. In the manifold there is a restricting island, which restricts the melt stream in such a way that an approximately uniform melt distribution is achieved over the entire width.

The manifold is geometrically designed by pursuing theoretical considerations with the aid of corresponding computer programs.

In the case of coextrusion, two or more melt streams are combined, the application of an additional layer of melt on top generally being regulated with the aid of what are known as manifold-type dies. Adapters are known, for example, from DE-A 37 41 793. These are exchangeable single-part or multi-part slides, the profile of which has been adapted in advance to the desired distribution profile. Lamella adapters are known for example from EP 0 418 681 A2. Here, the width of the extrusion profile can be influenced by a multiplicity of actuators, known as lamellae. The control can take place by means of a control loop, which controls the position of the lamellae and the throughput of the extruder on the basis of layer thicknesses and application widths measured on the extrusion product.

The adaptation of the distribution by means of a manifold-type die takes place by actuating elements accessible on the upper side of the extrusion die, which constitute part of the manifold-type die. These may be, for example, bolts, thermal expansion bolts or piezotranslators (see for example EP 0 418 681 A2).

In the die outlet region, the cross section of the extrudate can be additionally regulated with the aid of profile dies, known as flex lips or superflex lips (see for example EP-A 435 078, EP-A 367 022, EP-A 484 841).

### OBJECT AND SOLUTION

Extrusion dies for the extrusion of flat webs of thermoplastic materials generally have manifolds with central melt feed, which in plan view have the shape of a coat hanger or a fish tail. If they are properly designed, good results are achieved in this way for many applications, both in the case of single extrusion and in the case of coextrusion.

Difficulties are encountered, however, when extruding thermoplastic materials which have visible fillers, such as for example BaSO₄ particles. Due to the differing flow conditions in the manifold, partial segregation of the melt fed in, with the initially still homogeneously distributed filler, is virtually unavoidable. These segregations lead to the fillers being depleted or concentrated visually perceptible depletion or concentration of the fillers in the central region and at the same time concentration or depletion of the fillers in the edge regions of the extrudates obtained. This is undesired of course, since the aim is to achieve a homogeneous distribution.

The present invention is based on the object of providing filled films and sheets by way of extrusion or coextrusion, in which the distribution of filler in the final product is largely uniform.

Since the layer thickness distribution of coextruded layers with conventional extrusion dies with central melt feed is never completely uniform, even when the manifold is properly designed, and can therefore always be further improved, the present invention is based on the further object of making the layer thickness distribution in the coextrusion of films and sheets more uniform and of providing products that are improved in this respect.

The stated objects are achieved by an
extrusion die for the shaping of extruded melts of thermoplastic materials into film or sheet webs, substantially comprising the die body (1), at least one orifice for the melt feed (2) into a manifold (3) with at least one restricting island (4) and a slot-shaped die outlet region (5),
   characterized in that
the melt feed (2) into the manifold (3) takes place laterally with respect to the direction of extrusion (E) predetermined by the die outlet region (5).

The extrusion die according to the invention can be used in the processes known per se for producing films or sheets from thermoplastic material in a known way by extrusion or coextrusion.

The process according to the invention can be used to obtain extruded films or sheets of thermoplastic material which contain a particulate filler, the concentration of the filler, with respect to the web cross section, in the center of the outer thirds of the film or sheet web and in the central region of the extruded web deviating by no more than +/−15%, preferably no more than +/−10%, particularly preferably no more than +/−3% or even no more than +/−1%.

Furthermore, the invention can be used to obtain coextruded films or sheets of thermoplastic material in which the layer thickness of the layers for which the melt feed (2) into the manifold (3) takes place laterally with respect to the direction of extrusion (E) predetermined by the die outlet region, with respect to the web cross section, deviates in the center of the outer thirds of the film or sheet web and in the central region of the web by no more than +/−15%, preferably no more than +/−10%, particularly preferably no more than +/−3% or even no more than +/−1%.

The lateral feed achieves the effect that, overall, the melt is deflected only in one direction, to the right or to the left. Surprisingly, more uniform flow conditions in comparison with the prior art are evidently achieved overall as a result. This effect manifests itself advantageously in the fact that the known segregation in the case of filled melts is largely prevented or displaced into the outer edge regions, for example 10% of the width starting from the outer edges, which can be cut off by edge trimming. It is found to be a further advantage that more uniform layer thickness distributions can be achieved by means of the extrusion die according to the invention in the coextrusion of films or sheets than was previously possible.

The invention is explained in more detail by FIG. 1, without being restricted to this representation.

FIG. 1: perspective diagram, partly in section, of an extrusion die according to the invention with lateral melt feed (S) at an angle of 90° in relation to the direction of extrusion (E).

### LIST OF REFERENCE NUMERALS

1=die body
2=melt feed
3=manifold
4=restricting island
5=die outlet region
6=side plate for sealing
E=direction of extrusion
S=direction of melt feed

### IMPLEMENTATION OF THE INVENTION

Extrusion Die

The invention relates to an extrusion die for the shaping of extruded melts of thermoplastic materials into film or sheet webs.

This substantially comprises the die body (1), at least one orifice for the melt feed (2) into a manifold (3) with at least one restricting island (4) and a slot-shaped die outlet region (5).

The extrusion die may have altogether a number of manifolds that are independent from one another. There may be one or more restricting islands per manifold.

For structural design reasons, it is often expedient to provide the lateral die regions with side plates (6), for example for reinforcement, heating and sealing.

A major characterizing feature of the invention is that the melt feed (2) into the manifold (3) takes place laterally with respect to the direction of extrusion (E) predetermined by the die outlet region (5). It is immaterial here at which point of the die body material is initially introduced. For example, the melt may be initially led centrally into the die body and then correspondingly deflected, so that it is fed laterally into the manifold.

The extrusion die is distinguished by the fact that, with respect to the plane of a cross section through the die body, preferably corresponding to the plane which is formed by a relatively large extrudate surface area and runs through the width of the die outlet and the manifold, the direction of the melt feed (S) into the manifold and the direction of extrusion (E) form an angle of from 30 to 135°, preferably from 60 to 120°, particularly preferably from 80 to 100°. An angle of, for example, 90° is favorable.

The manifold (3) may have the form of a (half) coat-hanger manifold, a fish-tail manifold or a T-shaped manifold.

The cross section of the manifold (3) may be circular, rectangular, oval, elliptical or have a transitional form of the cross sections mentioned.

Preferably, in particular in the case of coextrusion dies, the manifold cross section is designed with an aspect ratio of manifold width to manifold height of from 3 to 10 (manifold width) to 1 (manifold height), preferably from 7 to 3.5 to 1, particularly preferably from 6 to 4 to 1.

It may be an extrusion die for the extrusion of a single layer of plastic (single extrusion).

It may also be a coextrusion die for the simultaneous extrusion of a number of layers of plastic, for example two, three or four layers (or in individual cases even several hundred layers), one on top of the other. In this case, the melt feed (2) into the manifold (3) takes place laterally with respect to the direction of extrusion (E) predetermined by the die outlet region (5), at least in the case of one of the layers of plastic, preferably the or an outer-lying layer of plastic. In individual cases, it may be expedient for structural design reasons to provide the manifold of a further layer, for example a thick core layer in the case of a sheet which is to be provided with a thinner additional layer, in a known way centrally with a centrally arranged melt feed. Preferably, all the manifolds are designed to be lateral according to the invention, in particular if they are intended to distribute polymers with fillers that have a segregating tendency or coextruded layers. In this case, it may be expedient for structural design reasons to feed the manifolds from different points in each case.

In the case where it is designed as a coextrusion die, the extrusion die may be provided in a way known per se with a manifold-type die. For example, a lamella adapter may be used. According to EP 0 418 681 A2, the width of the extrusion profile can be influenced by a multiplicity of actuators, known as lamellae. The control can take place by means of a control loop, which controls the position of the lamellae and the throughput of the extruder on the basis of layer thicknesses and application widths measured on the extrusion product. The adaptation of the distribution by means of a manifold-type die takes place by actuating elements accessible on the upper side of the extrusion die, which constitute part of the manifold-type die. These may be, for example, bolts, thermal expansion bolts or piezotranslators (see for example EP 0 418 681 A2).

The extrusion die may also be provided in the die outlet region in a way known per se with a profile die. The profile die serves for finely regulating the emerging melt profile, in that an outlet region formed with a thin wall is deformed under pressure exerted by actuating elements, for example by bolts, thermal expansion bolts or piezotranslators, in a corresponding way. It is suitable for example for the die outlet region to be configured as a flexible lip or so-called “superflex lip” (see for example EP-A 435 078, EP-A 367 022, EP-A 484 841) or as a membrane (Grog et al. (Kunststoffe 84 (1994) 10, pages 1352-1358).

Process

The extrusion die according to the invention can be used in the processes known per se for producing films or sheets from thermoplastic material in a known way by extrusion or coextrusion.

For this purpose, thermally plasticated melt is fed in by means of one extruder in the case of single extrusion or a number of extruders in the case of coextrusion. Additional devices, such as for example a melt pump or a melt filter, may be arranged in a way known per se between the extruder and the extrusion die. The extruded webs may subsequently be fed to a polishing stack or a calibrating device. Films may, for example, be led over individual cooled rollers in the so-called “chill-roll” process.

Depending on the plastic, the processing temperatures lie in the range from 150 to 320° C. Polymethyl methacrylate plastics, for example, can be processed in the range from 180 to 300° C.

Films and sheets

Films may, for example, have a thickness in the range from 5 to 250 μm. Sheets may have a thickness in the range from 0.1 mm to 100 mm. The widths of the extruded webs may, for example, lie from 100 mm to 4000 mm.

Extruded or coextruded films or sheets may, for example, consist of a polymethacrylate plastic, an impact-modified polymethyl methacrylate plastic, a polycarbonate plastic, a polystyrene plastic, a styrene-acrylonitrile plastic, a polyethylene terephthalate plastic, a glycol-modified polyethylene terephthalate plastic, a polyvinyl chloride plastic, a transparent polyolefin plastic, an acrylonitrile-butadiene-styrene (ABS) plastic or combinations or mixtures (blends) of the plastics mentioned.

Preferred are polymethyl methacrylate plastics with a methyl methacrylate monomer content of at least 80, preferably at least 90% by weight and, if appropriate, 0 to 20, preferably 0 to 10% by weight of further vinylically copolymerizable monomers, such as for example C₁ to C₈ alkyl esters of acrylic acid or of methacrylic acid, for example methyl acrylate, ethyl acrylate, butyl acrylate, butyl methacrylate, hexyl methacrylate, cyclohexyl methacrylate, styrene and styrene derivatives, such as for example α-methyl styrene or p-methyl styrene. Further monomers may be acrylic acid, methacrylic acid, maleic anhydride, hydroxy esters of acrylic acid or of methacrylic acid etc.

Filled Films or Sheets

Extruded films or sheets of thermoplastic material, which contain a particulate filler, for example in particle sizes of from 1 μm to 10 mm, preferably of from 3 to 50 μm, particularly preferably 5-20 am, can be produced in an advantageous way using the extrusion die according to the invention.

In the case of extruded films or sheets of thermoplastic material which contain a particulate filler, the concentration of the filler in the layers for which the melt feed (2) into the manifold (3) takes place laterally with respect to the direction of extrusion (E) predetermined by the die outlet region is very uniform. With respect to the web cross section, the filler concentration in the center of the outer thirds of the film or sheet web or of the filled layers extruded according to the invention, and in the central region of the extruded web, deviates by no more than +/−15%, preferably no more than +/−10%, particularly preferably no more than +/−3% or even no more than +/−1%. The web cross section is the cross section transversely to the direction of extrusion (E).

The deviation can be determined by making the smaller measured value equal to 100%. Usually this is the measured value measured in the center of the web, since the filler tends to be depleted there. This relationship also applies to film or sheet webs in which a certain edge trimming is subsequently performed, for example up to 15% from both sides, since the particularly critical region in the center of the web of plastic is always compared with the rather less critical edge regions.

The deviation can consequently be determined by dividing the film or sheet web over the width into three approximately equal parts and comparing the filler concentration of a sample from the center of the central third with the filler concentration of a sample from the center of one of the outer thirds, the smaller measured value being made equal to 100%.

The filler concentrations in the plastic can be determined on the basis of the respectively contained filler by suitable analytical methods which are familiar to a person skilled in the art. Standardized methods as well as non-standardized or otherwise validated methods can be applied. Suitable methods are, for example, ashing in the case of inorganic particles, i.e. ashing of the samples with subsequent weighing, if appropriate additional image analysis or spectroscopy. Furthermore, mention should be made of image-analysis measuring methods comprising counting the number of particles, evaluations regarding the number or surface area in plan view or through-view. Optical methods, such as for example determination of the transmission, may likewise be suitable.

Commercially available fillers which can be processed in thermoplastic material are, for example, minerals such as cristobalite, aluminum oxides, aluminum hydroxides and derivatives, for example alkaline and alkaline earth double oxides and alkaline earth hydroxides, clays, silicon dioxide in its various modifications, silicates, aluminosilicates, carbonates, phosphates, sulfates, sulfides, oxides, carbon, metals and metal alloys. Furthermore, synthetic materials such as ground glass, ceramic, porcelain, slag, finely distributed synthetic SiO₂ are suitable. Mention should be made of silica modifications such as quartz (ground quartz), tridymite and cristobalite, as well as kaolin, talc, mica, feldspar, apatite, baryte, gypsum, chalk, limestone and dolomite. Also suitable are polymeric fillers, such as for example in general granules or pellets, particles or powders of other thermoplastics, elastomers or thermosetting materials. If appropriate, mixtures of fillers may also be used.

The filler content in the extrudates may lie, for example, in the range from 0.001 to 25% by weight. The fillers may be present in the expedient particle sizes, for example from 1 μm to several mm, and may be obtained for example on the basis of the known processes by crushing and grinding.

Particulate fillers may be, for example, insoluble dyes, such as for example BaSO₄ particles which have a size in the range from 1 to 100, preferably in the range from 5 to 20 μm, and may be contained in the thermoplastic material for example in concentrations of from 0.001 to 30, preferably 0.01 to 5% by weight.

Similarly, other fillers or pigments, such as for example TiO₂ or else poorly melting granules or pellets, for example of cast, high-molecular-weight polymethyl methacrylate, may be contained.

Coextruded Films or Sheets

Coextruded films or sheets of thermoplastic materials can be produced in an advantageous way using the extrusion die according to the invention.

The layer thickness, which can be measured with respect to the web cross section in the center of one of the two outer thirds of the film or sheet web of the extruded film or sheet web, of the layers for which the melt feed (2) into the manifold (3) takes place laterally with respect to the direction of extrusion (E) predetermined by the die outlet region deviates in this case in relation to the layer thickness which can be measured in the center of the web by no more than +/−15%, preferably by no more than +/−10%.

This is particularly advantageous for example if a coextruded layer contains a soluble additive with which greatly fluctuating layer thicknesses can lead to impairments. This may be, for example, a soluble dye with which relatively greatly fluctuating layer thicknesses lead to different color impressions which can be easily perceived by the human eye. With other additives, such as for example UV absorbers, lower concentrations can be chosen for use on account of the very uniform layer thickness distribution according to the invention, since an excessive concentration with the intention of reliably covering thinner regions is no longer necessary.

The deviation can be determined by making the smaller measured value equal to 100% and relating the second measured value to it. The described maximum deviation also applies to film or sheet webs with which a certain edge trimming is subsequently performed, for example up to 15% from both sides, since the particularly critical region in the center of the web of plastic is also compared in this case with the rather less critical edge regions.

The deviation can consequently be determined by dividing the film or sheet web over the width into three equal parts and comparing the layer thickness of a coextruded layer of a sample from the center of the central third with the layer thickness of a sample of the same coextruded layer from the center of one of the outer thirds, by the smaller measured value being made equal to 100%.

The layer thickness of a coextruded layer can be determined by suitable analytical methods, for example by microscopic measurement of microtome sections.

1. An extrusion die for the shaping of extruded melts of thermoplastic materials into film or sheet webs, substantially comprising the die body (1), at least one orifice for the melt feed (2) into a manifold (3) with at least one restricting island (4) and a slot-shaped die outlet region (5),
characterized in that
the melt feed (2) into the manifold (3) takes place laterally with respect to the direction of extrusion (E) predetermined by the die outlet region (5).

2. The extrusion die as claimed in claim 1, characterized in that, with respect to the plane of a cross section through the die body, the direction of the melt feed (S) into the manifold and the direction of extrusion (E) form an angle of from 30 to 135°.

3. The extrusion die as claimed in claim 1 or 2, characterized in that the manifold (3) has the shape of a coat-hanger manifold, a fish-tail manifold or a T-shaped manifold.

4. The extrusion die as claimed in one or more of claims 1 to 3, characterized in that the cross section of the manifold (3) is circular, rectangular, oval, elliptical or polygonal or has a transitional form of the cross sections mentioned.

5. The extrusion die as claimed in one or more of claims 1 to 4, characterized in that the manifold cross section has an aspect ratio of manifold width to manifold height of from 3 to 10 to 1.

6. The extrusion die as claimed in one or more of claims 1 to 5, characterized in that it is an extrusion die for the extrusion of a single layer of plastic.

7. The extrusion die as claimed in one or more of claims 1 to 5, characterized in that it is a coextrusion die for the simultaneous extrusion of a number of layers of plastic one on top of the other, the melt feed (2) into the manifold (3) taking place laterally with respect to the direction of extrusion (E) predetermined by the die outlet region (5), at least in the case of one of the layers of plastic.

8. A process for producing films or sheets of thermoplastic material in a way known per se by extrusion or coextrusion, an extrusion die as claimed in one or more of claims 1 to 7 being used for the shaping.

9. Extruded films or sheets of thermoplastic material which can be produced on the basis of a process as claimed in claim 8, containing a particulate filler, characterized in that the concentration of the filler in the layers for which the melt feed (2) into the manifold (3) takes place laterally with respect to the direction of extrusion (E) predetermined by the die outlet region deviates by no more than +/−15% with respect to the web cross section in the center of the outer thirds of the film or sheet web and in the central region of the extruded web.

10. Coextruded films or sheets of thermoplastic material which can be produced on the basis of a process as claimed in claim 8, characterized in that the layer thickness of the layers for which the melt feed (2) into the manifold (3) takes place laterally with respect to the direction of extrusion (E) predetermined by the die outlet region deviates by no more than +/−15% with respect to the web cross section in the center of the outer thirds of the film or sheet web and in the central region of the web.

11. Extruded or coextruded films or sheets as claimed in claim 9 or 10, characterized in that they consist of a polymethyl methacrylate plastic, an impact-modified polymethyl methacrylate plastic, a polycarbonate plastic, a polystyrene plastic, a styrene-acrylonitrile plastic, a polyethylene terephthalate plastic, a glycol-modified polyethylene terephthalate plastic, a polyvinyl chloride plastic, a transparent polyolefin plastic, an acrylonitrile-butadiene-styrene (ABS) plastic or combinations or mixtures (blends) of the plastics mentioned.
